(19) United States
(12) Patent Application Publication
(10) Pub. No.: US 2012/0192696 A1
(43) Pub. Date: Aug. 2, 2012

(54) CABLE STRIPPING TOOL

(76) Inventor: Martin Joseph John Barrett, Birmingham (GB)

(21) Appl. No.: 13/498,231

(22) PCT Filed: Sep. 25, 2009
(86) PCT No.: PCT/GB2009/002307

§ 371 Date: Apr. 18, 2012

(51) Int. Cl. H02G 1/12; B26D 3/08

(52) U.S. Cl. 83/881; 83/879

(57) ABSTRACT

A cable stripping tool 200 having a body 201 which comprises an arm 202, a cable mounting portion 203 and a blade assembly 205 that is movable between a retracted position and an engaging position, the cable mounting portion 203 comprises means having first and second cable mounting axes, wherein the arm 202 extends from the cable mounting portion 203 in a direction between the first and second mounting axes.

This invention relates to a cable stripping tool and, in particular although not exclusively, it relates to a cable stripping tool for preparing the end of an armoured cable for connection to other devices.

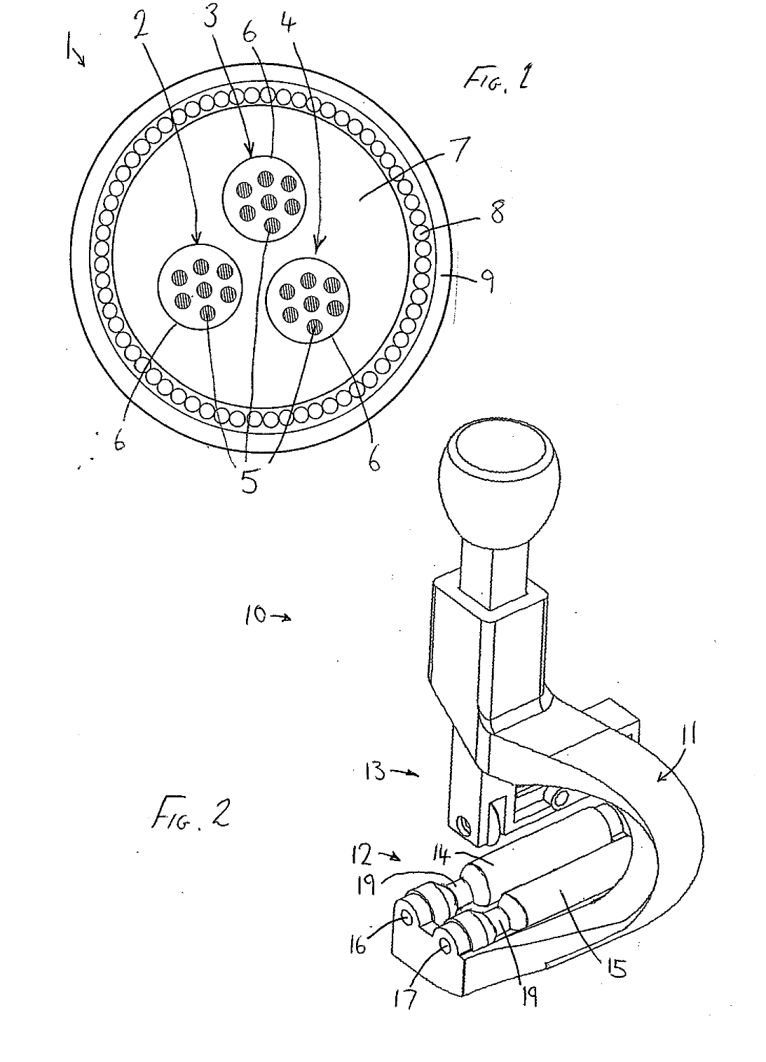

Armoured cables are commonly used to carry electrical power in harsh environments, such as underground. They typically include a plurality of conductor wires surrounded by armour to protect the conductor wires from inadvertent damage. A cross section through a typical armoured cable 1 is shown in FIG. 1. The cable 1 comprises three insulated conductor wires 2, 3, 4. The conductor wires 2, 3, 4 each include a plurality of braided wire strands 5, which are surrounded by an insulating sheath 6. The conductor wires extend through a core material 7. The core material core material 7 is surrounded by a plurality of steel armour wires 8, which protect the conductor wires. The armour wires 8 are covered with an outer sheath 9 of plastics.

To prepare the cable 1 for connection to a device (not shown), a portion of the outer sheath 9 and the armour wires 8 are removed. A protective shroud and a first part of a gland are fed on to the cable 1. A further amount of the outer sheath is removed and the armour wires are thereby exposed and engage with a first part of the gland. A second part of the gland is then screwed on to the first part compressing the armour wires therebetween to secure the cable.

The cable is commonly prepared using a hack saw and a knife to make the relevant cuts. This is hazardous to the user and injury is common due to the degree of control required to saw and cut the cable. Furthermore, this method can lead to inaccurate cuts, particularly when employed by inexperienced or unskilled workers.

According to a first aspect of the invention there is provided a cable stripping tool comprising a body, a cable mounting portion and a blade assembly that is movable relative to the cable mounting portion between a retracted position and an engaging position, the blade assembly comprising a first blade and a second blade and wherein the second blade is movable relative to the first blade between an operable position and an inoperable position.

This tool is advantageous as it simplifies the cable stripping process and minimizes the risk of injury. The first and second blades can be used to make two circumferential cuts in the outer sheath and as the second blade is movable relative to the first it can be moved to an inoperable position while the first blade makes a deeper cut. Further, the movable blade assembly provices a retracted position in which assembly provides a retracted position in which it is easy for a user to place the tool around a cable to be prepared and an engaging position in which the cable is clamped into the tool.

The blade assembly may include a slide member that guides the blade assembly between the retracted position and the engaging position, the slide member including a slide assembly that controls the movement of the slide member. The slide assembly may comprise a screw threaded member. Controlled movement of the blade assembly may be effected by rotation of the screw threaded member. The slide assembly may include a ratchet mechanism.

This is advantageous as the screw threaded member can be arranged to provide a mechanical advantage to urge the first blade and second blade to cut the cable. The ratchet mechanism is advantageous as it can be disengaged to allow swift movement of the blade assembly between the retracted and engaging positions, while the screw threaded member provides precise control of the movement of the blade assembly. Thus, the tool can be clamped around the cable using the ratchet mechanism and then the advancement of the blade assembly to effect cutting can be provided by the screw threaded member.

The mounting portion may be arranged to receive the cable in a first orientation and a second orientation, and comprise means to permit rotation of the cable relative to the tool in both the first and second orientations. The first orientation may be 90° to the second orientation. The mounting portion is advantageous as it allows both circumferential cuts and axial cuts to be made in a cable.

In particular, the mounting portion may comprise a pair of rollers arranged parallel to one another, both rollers having a circumferential groove aligned with either the first or second blade. The groove in each of the rollers is advantageous as it provides a recess in which the cable can be received when in the second orientation.

Alternatively, the rollers may both include a circumferential ridge aligned with either the first or second blade. The ridge in each of the rollers 20 provides an abutment for the cable.

In an alternative embodiment of the invention, the pair of rollers may be substituted by a plurality, usually at least four, of resiliently mounted ball-bearings. The freedom with which a ball-bearing rotates about its central point is advantageous because it allows for a greater degree of flexibility when positioning the cable in the tool.

According to a second aspect of the invention, there is provided a cable stripping tool comprising a body, a cable mounting portion and a blade assembly that is movable relative to the cable mounting portion between a retracted position and an engaging position, the blade assembly comprising a first blade and a second blade and wherein the first blade is connected to the second blade such that, in use, the pressure applied by the second blade to a cable is lower than the pressure applied by the first blade.

According to a third aspect of the invention, there is provided a cable stripping tool, comprising a body, a cable mounting portion and a blade assembly that is movable relative to the cable mounting portion between a retracted position and an engaging position, the blade assembly comprising a first blade, the mounting portion being arranged to receive the cable in a first orientation and a second orientation, the cable mounting portion comprising means to permit rotation of the cable relative to the tool in both the first and second orientations.

Thus, a system is provided that may lack the second blade of the first aspect of the invention, but still allows the cable to be received in two different orientations. Accordingly, it is still possible to make the two different orientation cuts required without having to resort to a hacksaw. This would not be possible with prior art tube-cutting apparatus.

The first orientation is preferably substantially 90° to the second orientation. The mounting portion is advantageous as it allows both circumferential cuts and axial cuts to be made in a cable.

In particular, the mounting portion may comprise a pair of rollers arranged parallel to one another, both rollers having a circumferential groove aligned with either the first or second blade. The groove in each of the rollers is advantageous as it provides a recess in which the cable can be received when in the second orientation.

Alternatively, the rollers may both include a circumferential ridge aligned with either the first or second blade. The ridge in each of the rollers provides an abutment for the cable.

Alternatively, the pair of rollers may be substituted by resiliently mounted ball-bearings, such as those described in the first embodiment of the invention.

The cable stripping tool may be arranged such that, when a cable is placed across the rollers in the second position, there is no obstacle to the cable laying entirely straight perpendicularly to both rollers. In prior art tube cutting devices, the support for the blades would tend to block the cable being position in any other direction than along the rollers.

The cable stripping tool may have any of the optional features of the first aspect of the invention.

According to a fourth aspect of the invention there is provided a cable stripping tool comprising a body, a cable mounting portion and a blade assembly that is movable relative to the cable mounting portion between a retracted position and an engaging position, the blade assembly comprising a first blade, the mounting portion being arranged to receive the cable in a first orientation and a second orientation, and comprising means to permit rotation of the cable relative to the tool in both the first and second orientations wherein the blade assembly includes a slide member that guides the blade assembly between the retracted position and the engaging position, the slide member including a slide assembly that controls movement of the slide member and wherein the slide assembly includes a ratchet mechanism.

Preferably, the slide assembly further comprises a screw threaded member. More preferably, the screw threaded member and the ratchet mechanism are engageable, e.g. to locate the slide assembly in one or the other of the retracted and engaging positions. Even more preferably, engagement and/or disengagement of the screw thread member to and/or from the ratchet mechanism is controlled by an actuator. Preferably, the ratchet mechanism comprises a spring. More preferably, the spring is biased so that the slide member is urged toward the retracted position.

According to a fifth aspect of the invention there is provided a cable stripping tool having a body comprising an arm, a cable mounting portion and a blade assembly that is movable between a retracted position and an engaging position, the cable mounting portion comprising means having first and second cable mounting axes, wherein the arm extends from the cable mounting portion in a direction between the first and second mounting axes.

Preferably, the first cable mounting axis is substantially 90° to the second cable mounting axis.

Preferably, the arm extends from the mounting portion at approximately 45° from the first cable mounting axis.

Preferably, the arm is formed integrally with the mounting portion.

Preferably, a distal end of the arm supports the blade assembly.

Preferably, the arm is curved upwards with respect to the mounting portion.

Preferably, the blade is directly above the mounting portion. More preferably, the blade is directly above the point in which the first and second cable mounting axes intersect.

An advantage of the shape of the arm is that the cutting zone (i.e. the region in which the blade assembly reciprocates between the retracted and engaging positions) is not obstructed from view by any part of the body, in use, for example, when the cutting zone is viewed along any one of the cable mounting axes.

Preferably, blade assembly reciprocates linearly between the engaging and retracted positions. More preferably, the blade assembly is operable by control of a control member. The control member may be mounted to a screw threaded member.

Preferably, the blade assembly is operable to impart sufficient force on the blade to allow the blade to cut through the steel armour wire of an armoured cable.

The cable stripping tool may have any of the optional features of any the earlier aspects of the invention.

According to a sixth aspect of the invention there is provided a kit for connecting to a cable cutting device comprising a body, a cable mounting portion and a first blade support that is movable relative to the cable mounting portion between a retracted position and an engaging position, the kit comprising a second blade assembly adapted to connect to the first blade support such that it is movable with the first blade support between the retracted and engaging positions, wherein, when mounted to the first blade support, the second blade assembly and the first blade support provide two parallel blades, and in which, when the kit is mounted on the cable cutting device, the mounting portion is arranged to receive the cable in a first orientation and a second orientation, and comprise means to permit rotation of the cable relative to the tool in both the first and second orientations.

This is advantageous as a conventional cable stripping tool can be modified to include a second blade thereby making armoured cable preparation easy.

Preferably the kit includes an extension mount for connection to the mounting portion and adapted to provide a mount for a cable when the device is in use. The extension mount may comprise a set of rollers which extend, when mounted on the cable stripping tool, from the first

blade to the operable position of the second blade. The rollers may have a groove therein that lines up with one of the first blade or the second blade in its operable condition, when attached to the cable stripping tool.

The kit may comprise the cable stripping tool, or may be provided without it for fitting thereto.

The second blade assembly may comprise an attachment portion, a hinge and a second blade, wherein the second blade is movable relative to the

first blade support between an operable position and an inoperable position.
Alternatively, the positioning of the cable relative to the blade assembly may mean one of the blades is no longer in contact with the cable.

The second blade assembly may replace the blade of the cable cutting tool; in such a case the second blade assembly may also comprise a replacement first blade. Alternatively, the first blade of the cable cutting tool may be employed.

When attached to the cable cutting tool, the kit may form a cable cutting tool according to any of the preceding aspect of the invention.

There now follows by way of example only a detailed description of the present invention with reference to the accompanying drawings in which;

FIG. 1 shows a cross section through a typical armoured cable;

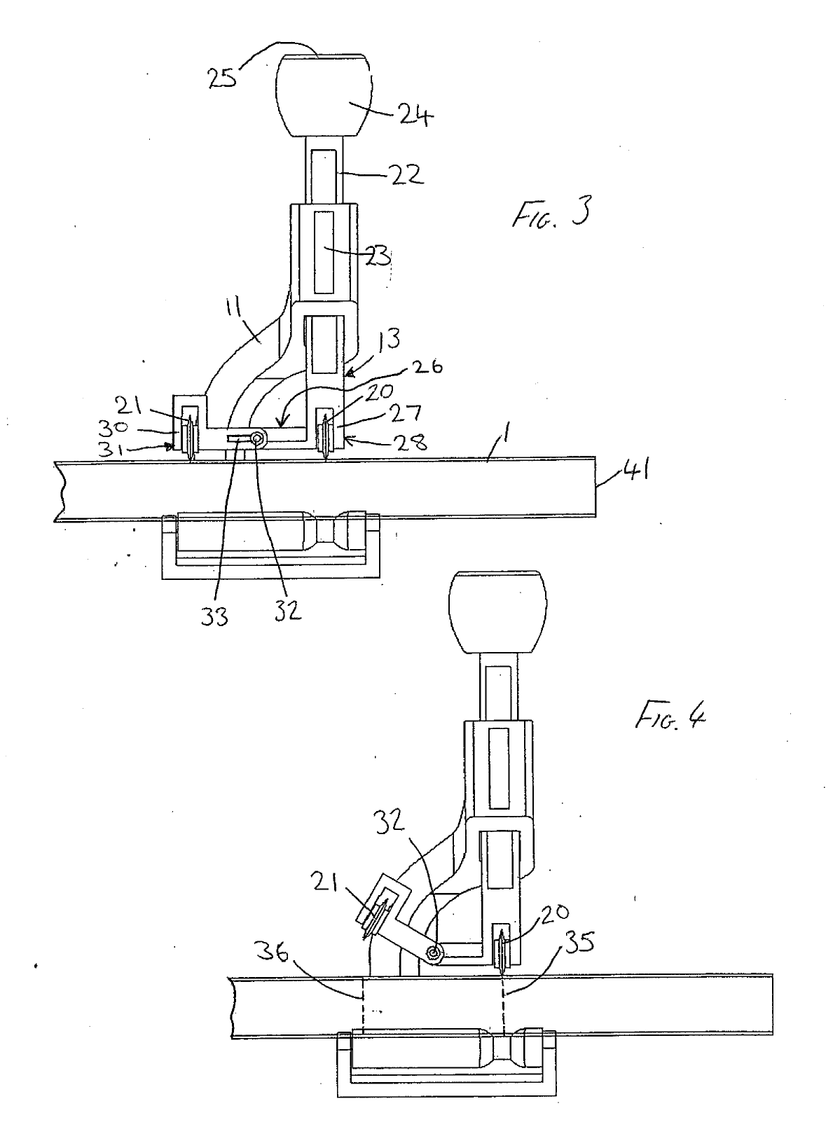

FIG. 2 shows a perspective view of an embodiment of the cable stripping tool of the invention;

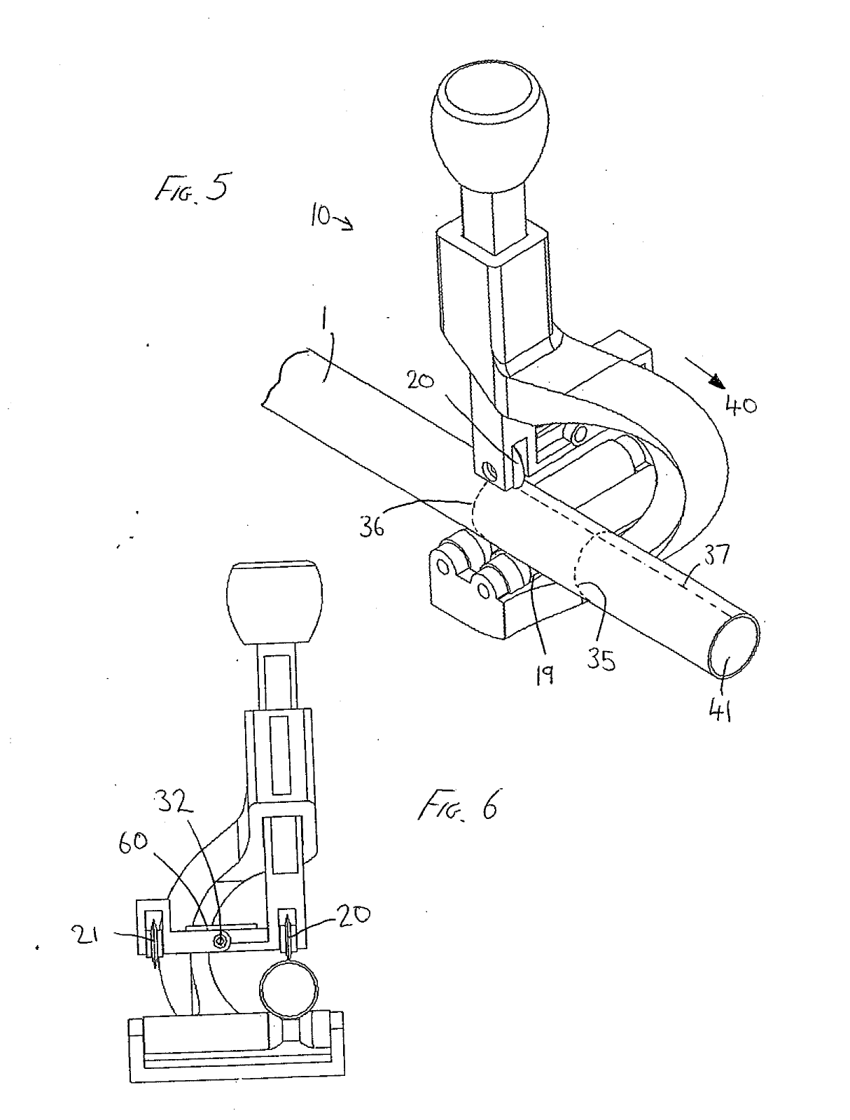

FIG. 3 shows a side view where the second blade is in an operable position;

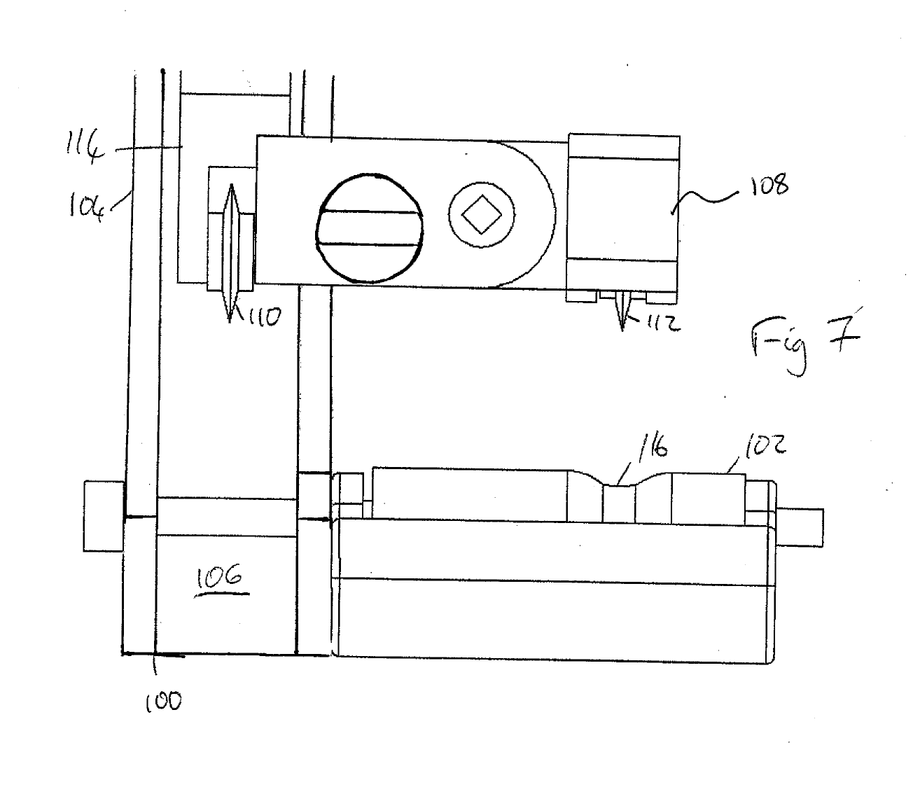

FIG. 4 shows a side view similar to FIG. 3 with the second blade in an inoperable position;

FIG. 5 shows the tool having a cable in situ;

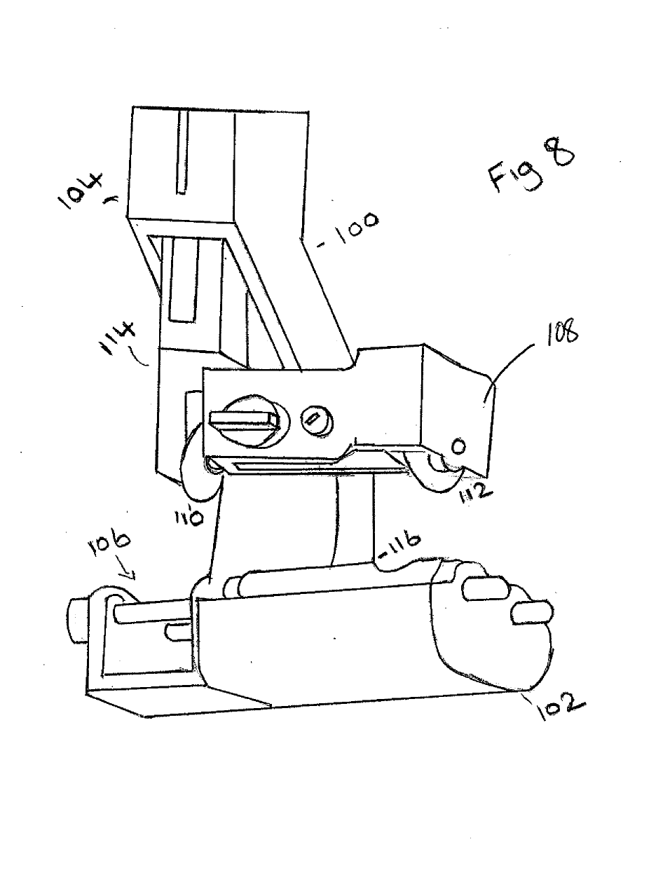

FIG. 6 shows a side view of a second embodiment of the tool;

FIG. 7 shows a front elevation of a tool formed of a kit of parts according to a third embodiment of the invention;

FIG. 8 shows a perspective view of the tool of FIG. 7;

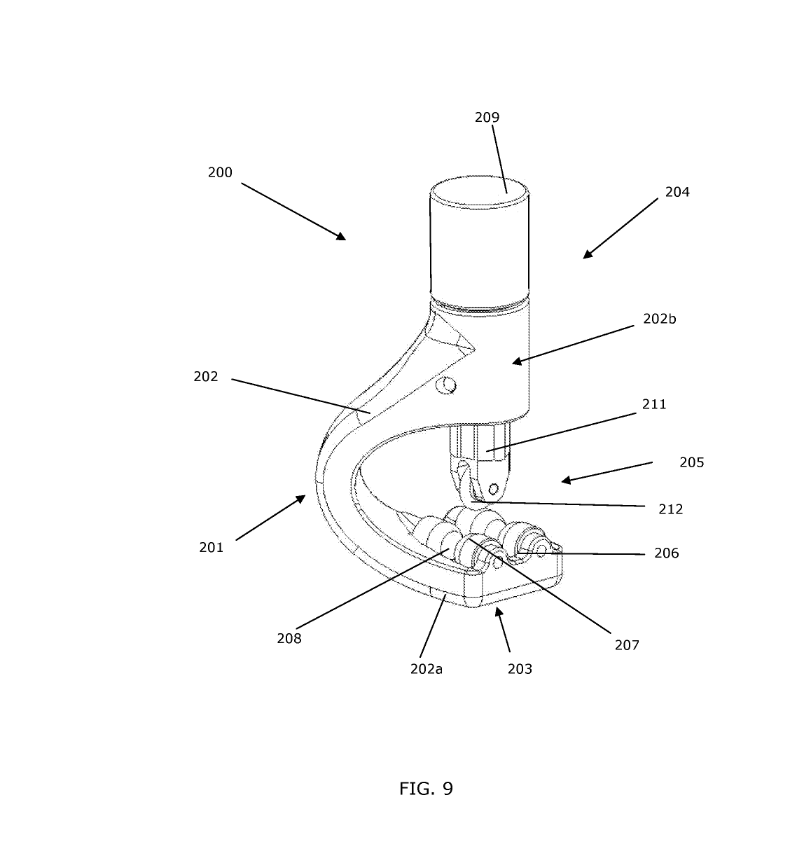

FIG. 9 shows a perspective view of a further embodiment of the tool;

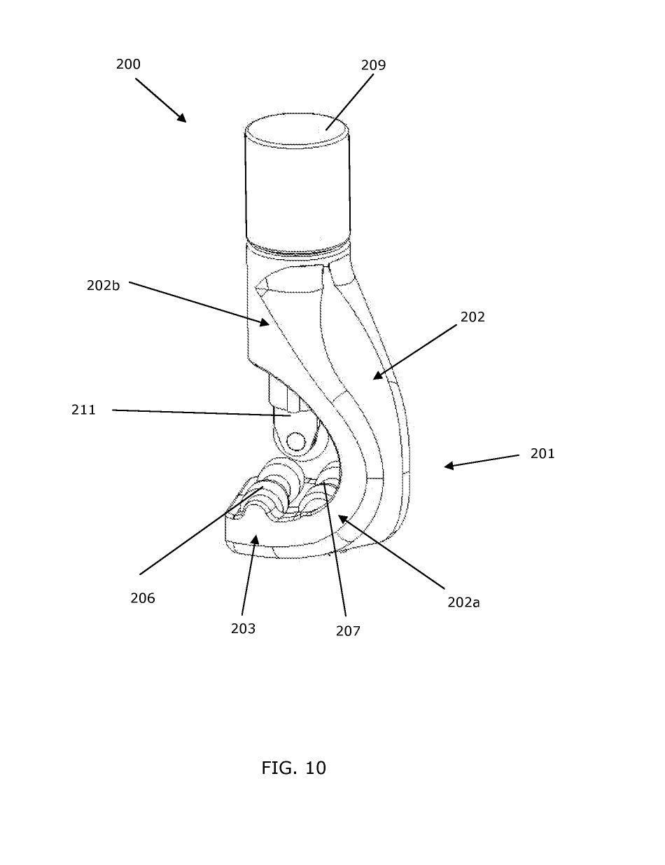

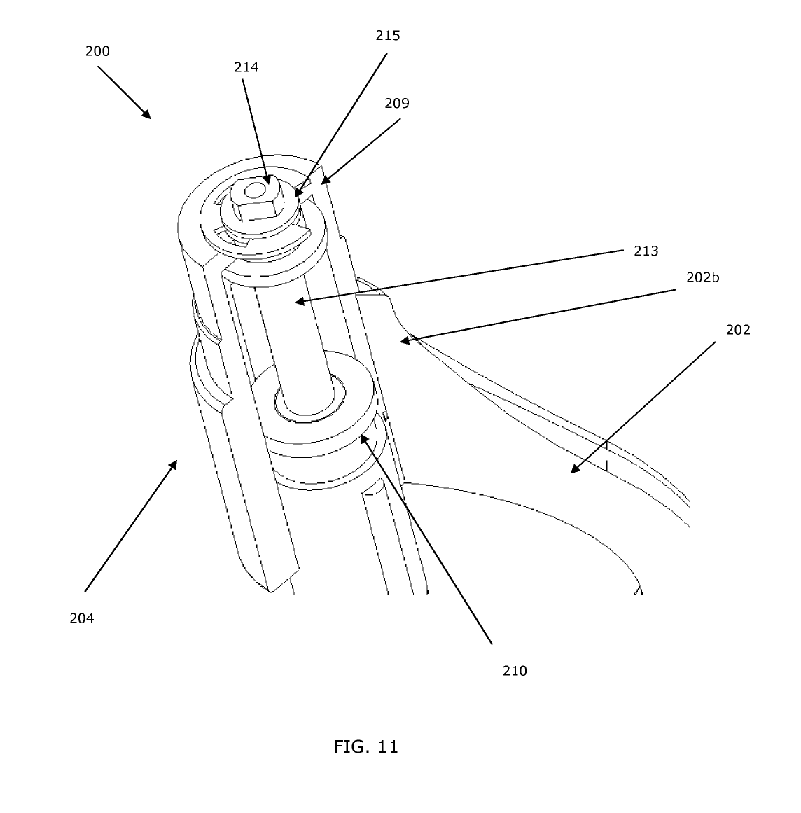

FIG. 10 shows a different view of the tool of FIG. 9;

FIG. 11 shows a partial cutaway view of the tool of FIG. 9;

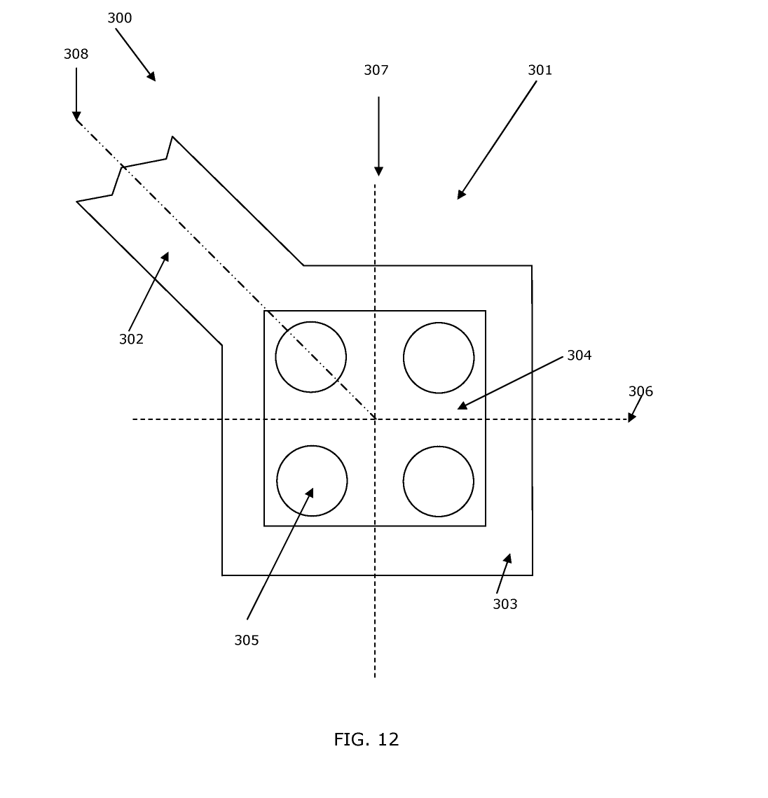

FIG. 12 shows a plan view of a further embodiment of the tool; and

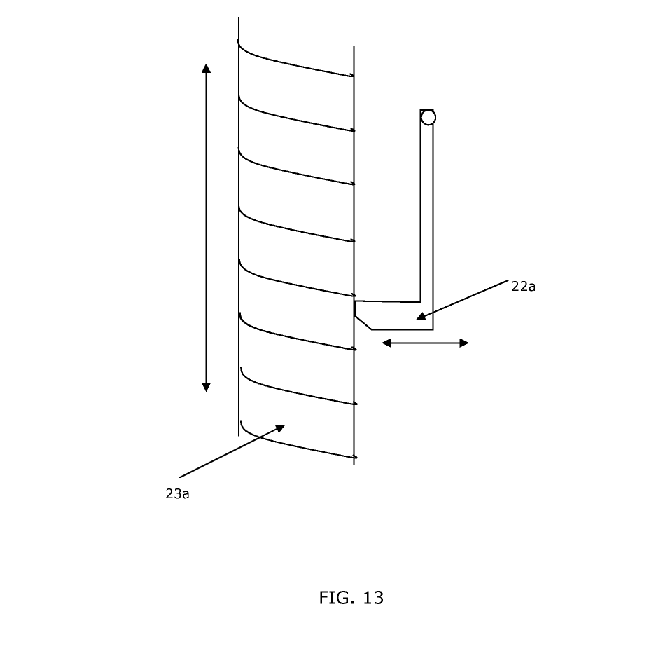

FIG. 13 shows a schematic of a ratchet mechanism.

Referring to FIGS. 2 to 5, there is shown a cable stripping tool 10 for preparing armoured cables 1 for connection to other devices. The cable stripping tool 10 comprises a body 11 that includes a cable mounting portion 12 and a movable blade assembly 13. The cable mounting portion 12 comprises a first roller 14 and a second roller 15 mounted parallel to one another. The rollers 14, 15 are fixed to the body 11 by axles 16, 17 that extend axially through the centre of the rollers 14, 15 and into complementary mounting apertures in the body II. The rollers 14, 15 can be removed from the body 11 for replacement, if necessary. The rollers 14, 15 both include a groove 19 that extends circumferentially through each of the rollers 14, 15. The circumferential groove 19 has inclined edges.

The blade assembly 13 (as best seen in FIGS. 3 and 4) comprises a first blade 20 and a second blade 21 spaced from the first blade 20. The spacing between the first blade 20 and second blade 21 is approximately 50 mm. The first and second blades are circular having a circumferential cutting edge and are adapted to rotate as they cut. It will be appreciated that the blades 20, 21 may be non-rotating, or alternatively different shapes, such as pointed blades. Rotating blades may be powered for ease of use. The blade assembly 13 includes a slide member 22 that extends through a guide aperture in the body 11 and controls movement of the blade assembly 13 relative to the cable mounting portion 12. The slide member 22 allows a user to position the blade assembly 13 for engagement with a cable placed on the cable mounting portion 12, abutting the rollers 14, 15. The blades 20, 21 are also removable and replaceable.

The slide member 22 includes a slide assembly 23 for controlling the movement of the blade assembly 13 toward and away from the cable mounting portion 12. The slide assembly 23 includes a screw threaded member 23a mounted on the slide member 22 that engages a ratchet mechanism 22a (as shown in FIG. 13). The screw threaded member 23a is controlled by a control knob 24. Rotation of the control knob 24 moves the slide member 22 with respect to the body 11 and thus the blade assembly 13 moves relative to the mounting portion 12. The ratchet mechanism also permits movement of the slide member 22. The ratchet mechanism includes a control button 25 that disengages the ratchet mechanism from engagement with the screw thread threaded member and allows the slide member 22 to slide freely in the body 11. On release of the control button 25, the ratchet mechanism re-engages to fix the slide member 22 in position. Thus, the screw threaded member and ratchet mechanism are used to move the blade assembly 13 between a retracted position and an engaging position. The ratchet mechanism also includes a bias spring that biases the slide member 22 such that it is urged toward the retracted position. In the engaging position, the blade assembly 22 contacts a cable placed on the mounting portion and clamps the cable between the mounting portion and the blade assembly. In the retracted position the blade assembly 13 is remote from the mounting portion allowing a cable to be placed in the tool.

The blade assembly 13 comprises an elongate housing member 26 having a first blade housing 27 at a first end 28 and a second blade housing 30 at its other end 31. The slide member 22 extends from the first end 28 of the blade assembly 13. The first blade housing 27 receives the first blade 20 and the second blade housing 28 receives the second blade 21. The blades 20, 21 are free to rotate in their respective housings 27, 28. The elongate housing member 26 includes a hinge 32 between the first and second housing portions 27 and 30. Thus, the second blade housing 30, and therefore the second blade 21, is moveable relative to the first blade housing 28. The hinged elongate housing member 26 allows the second blade 21 to move between an operable position (as shown in FIG. 3) and an inoperable position (as shown in FIG. 4). The hinge 32 includes a lock 33, which locks the second blade 21 in either the operable or inoperable positions.

In FIGS. 3 and 4, a cable 1 is shown mounted in the cable stripping tool 10. In FIG. 3, the second blade 21 is shown in the operable position where it is substantially parallel to the first blade 20. Accordingly the second blade is spaced from the rollers 14 and 15 of the mounting portion 12 substantially the same distance as the first blade 20. In the operable position the slide member 22 and slide assembly 23 can be used to bring both the first blade 20 and the second blade 21 into engagement with the cable 1. Thus, both the first blade 20 and second blade 21 are arranged to cut into the cable 1. In FIG. 4, the second blade 21 is shown in the inoperable position. In this position, the second blade 21 is arranged to be disengaged from the cable 1. Thus, in the inoperable position, only the first blade 20 is arranged to cut into the cable 1.

In use, the slide member 22 is moved from the mounting portion 13 to its retracted position to allow the cable 1 to be placed on the rollers 14, 15 of the mounting portion 13. In particular, the cable I is placed in a first orientation with respect to the tool 10 such that the cable is parallel to the rollers 14, 15 and lies such that the cable 1 abuts both rollers 14, 15. The second blade 21 is locked in the operable position by the lock 33. The blade assembly 13 is then brought into contact with the cable 1 by pressing the control button 25 to disengage the ratchet mechanism. The slide member 22 can then be moved freely until the blade assembly 13 abuts the cable 1 and then the control button 25 is released to re-engage the ratchet mechanism. The blade assembly is now in the engaging position. The control knob 24 is then rotated to actuate the screw threaded member to urge the first blade 20 and second blade 21 to pierce the outer sheath 9. The slide member 22 and body 11 may be calibrated with a scale such that the depth that the blade assembly cuts into a cable can be determined.

The user rotates the control knob 24 until they feel a change in resistance caused by the first and second blades 20 and 21 contacting the armour wires 8. The tool 10 can then be rotated about the cable 1 to affect two circumferential cuts. Thus, the cable 10 will rotate on the first and second rollers 14, 15 while the first blade 20 and the second blade 21 will rotate in their respective housings 27 and 30 making two spaced cuts into the outer sheath 9. The first blade 20 makes a first circumferential cut represented by dotted line 35. The second blade simultaneously makes a second circumferential cut represented by dotted line 36. The control knob 24 may be rotated in combination with rotating the tool 10 around the cable 1. This allows the blade assembly to progressively cut deeper into the outer sheath 9 as the tool 10 rotates.

Once the first and second circumferential cuts 35, 36 have been made, the lock 33 can be disengaged to allow the second blade 21 to be moved from the operable position to the inoperable position. The lock 33 is then reengaged to hold the second blade 21 in the inoperable position. The control knob 24 is then rotated further such that the first blade 20 applies further pressure to the armour wires 8 to cut part way through them. As before, the tool 10 is rotated around the cable 1 such that the first blade 20 makes a complete circumferential cut at a depth to cut part way into the armour wires 8. Thus, the first circumferential cut 35 is made deeper.

The control button 25 can then be pressed to disengage the ratchet mechanism and allow the blade assembly 13 to be moved to the retracted position. The orientation of the tool 10 with respect to the cable 1 is then changed so that the cable 1 extends perpendicular to the rollers 14, 15, as shown in FIG. 5. In this second orientation, in which the tool is rotated 90° to the first orientation, the cable I is received within the groove 19 of each of the rollers 14, 15. The groove 19 in each of the rollers 14, 15 and the first blade 20 are arranged such that the first blade 20 is aligned with and can engage the cable I when the blade assembly 13 is in the engaging position. Thus, as described above in relation to the circumferential cuts, the blade assembly 13 is moved from the retracted position to the engaging position using the control button 25 and ratchet mechanism. As will be appreciated, in this second orientation the cable 1 is only contacted .by the first blade 20. The control knob 24 can then be rotated to urge the first blade 20 to pierce the outer sheath 9. The user continues to turn the control knob 24 until they feel a change in resistance, which indicates that the first blade 20 has penetrated the outer sheath 9 and abuts the armour wires 8. The user then moves the tool 10 relative to the cable 1 in the direction of arrow 40 to make a longitudinal cut 37 in the cable 1. The longitudinal cut should extend from the second circumferential cut 36 made by the second blade 21, through the first circumferential cut 35 made by the first blade 20 to the end 41 of the cable 1.

The outer sheath 9 of the cable 1 between the first circumferential cut 35 and the end 41 can be removed. The outer sheath 9 of the cable 1 between the second circumferential cut 36 and the first circumferential cut 35 can also be removed. Further, as the first circumferential cut 35 was made part way through the armour wires 8, these can now be broken off by hand at the first circumferential cut 35. It is advantageous to ensure that the first circumferential cut 35 only extends part way through the armour wires 8 so that they can be removed by hand in a controlled manner. It will be appreciated by those skilled in the art that if the first circumferential cut 35 was made to a depth that extends through the armour wires 8 completely, then they would drop from the cable I when the outer sheath 9 was removed. This could be hazardous if working at height, for example.

In an alternative embodiment, as shown in FIG. 6, the lock 33 is removed and a resilient element 60 is affixed to the elongate housing member 26 spanning the hinge 32. Instead of the second blade 21 being arranged to move between an operable and inoperable position, the resilient element 60 limits the pressure that can be applied to the cable 1 by the second blade 21. In particular, when the first circumferential cut 35 and second circumferential cut 36 are made, the control knob 24 should be rotated until the first blade 20 is at a depth to cut part way through the armour wires 8. The second blade 21 will be under pressure to also cut to a depth corresponding to the depth of the first blade 20. However, the resilient element 60 is adapted to flex when the second blade 21 is placed under pressure thereby reducing the depth that the second blade 21 penetrates in comparison to the first blade 20. Thus, the hinge 32 allows the second blade 21 to rotate about the hinge limited by the resilience of the resilient element 60. Thus, in the second embodiment, the resilience of the resilient element 60 is chosen so that when the slide member 22 urges the first blade 20 to cut into the armour wires 8, the second blade 21 has penetrated only the outer sheath 9. The deeper first circumferential at 35 can therefore be made simultaneously with the second circumferential at 36 without the need to move the second blade 21 from the operable to the inoperable position. The resilient element 60 comprises an element of spring metal, although the resilience may be provided by a spring or the like.

In an alternative embodiment, as described later, the second blade is omitted. The two circumferential cuts can instead be made by moving the cable along its length between using the first blade to make each cut. It is to be noted that the cable can be put into the position shown in FIGS. 5 and 6 with the cable perpendicular to the rollers, thus also allowing the longitudinal cut to be made.

A cable stripping tool according to a third embodiment of present invention can also be provided as a kit of parts that may be attached to a suitable cable stripping (or tube cutting) tool. FIGS. 7 and 8 of the accompanying drawings show how this embodiment fits together.

A tube cutting tool 100, such as the “Large Tube Cutter” from Rothley Ltd of Wolverhampton, United Kingdom, is modified by the addition of the kit of parts forming this embodiment. The kit comprises a set of rollers 102, which attach to the lower part of the tube cutter, and replace the rollers that would otherwise be provided in the space 106 below the tube cutter's blade.

The kit also comprises a blade assembly 108, comprising first 110 and second 112 blades. This assembly replaces the blade that would otherwise be held in the blade support 114. It attaches to the blade support, so that it can be driven up and down with the blade support 114 relative to the body 104 of the tube cutter 100. The first 110 and second 112 blades are position parallel with each other.

When fitted to the tube cutter, the second blade 112 is positioned above a groove 116 in each of the rollers 102. This allows a cable to be positioned both laying between the rollers 102 along their length (the first position) and perpendicular to the rollers in the groove 116. The apparatus thus formed can then be used as described with respect to the first embodiment (FIGS. 2 to 5), with the circumferential cuts being made by the first 110 and second 112 blades together, followed by a longitudinal cut being made by the second blade 112 only; not that it is not required in this embodiment for the second blade to fold out of the way, as the first blade will not interfere with the longitudinal cut being made.

Referring now to FIGS. 9 to 11, there is shown an alternative embodiment of a cable stripping tool 200 according to the present invention. The tool 200 comprises a body 201 that includes an arm 202, a cable mounting portion 203, a slide assembly 204 and a moveable blade assembly 205. The cable mounting portion 203 comprises a first roller 206 and a second roller 207 mounted parallel to one another. The rollers 206, 207 both include a groove 208 that extends circumferentially around each of the rollers 206, 207. The circumferential groove 208 has inclined edges.

The rollers 206, 207 define two distinct orientations in which a cable may be mounted: a first mounting orientation which lies parallel too and in between the rollers 206, 207 and a second mounting orientation which lies orthogonal to the first mounting direction along the circumferential grooves 208 of the rollers 206, 207.

The arm 202 has a first arm end 202a and a second arm end 202b. The first arm end 202a is formed integrally with the mounting portion 203 and the second arm end 202b supports the movable blade assembly 205. The arm 202 upstands from the mounting portion 203 in a direction between the first and second mounting orientations and is curved such that the movable blade assembly 205 (and thus the blade 212) is positioned directly above the mounting portion 203. As will be appreciated, the curved shape of the arm 202 gives the user an unobstructed view of the cutting zone in either orientation. In other words the cutting zone is highly visible, in use, which increases accuracy of cutting, e.g. as a result of the user not having to alter his position when cutting. This is clearly shown when comparing the perspective views of the tool 200 in FIGS. 9 and 10. As can be seen, the cutting zone (i.e. the region directly beneath the moveable blade assembly 205) is highly visible to the user from both views.

Referring now to FIG. 11, there is shown a partial cutaway view of the tool 200 of the present invention. The slide assembly 204 comprises a control member 209, an actuating portion 210, an elongate housing member 211 having a blade 212 housed therein (as shown in FIGS. 9 and 10) and a screw threaded member 213.

A typical screw threaded member 213 is an M8 bar with left hand thread and standard pitch. Other threaded bars may be used.

The blade 212 is substantially the same as the blades already described in earlier embodiments of the invention and will not be discussed further.

The screw threaded member 213 is controlled by the control member 209. The control member 209 surrounds the actuating portion 210 and screw threaded member 213 and is secured in place by means of bolt 214. A washer 215 ensures that the slide assembly 204 remains intact. Rotation of the control member 209 in one direction causes the actuating portion 210 to move linearly in respect to the longitudinal axis of the screw threaded member 213. Thus, the actuating portion 210 urges the elongate housing member 211, and hence the blade 212, into an engaging position. Similarly, rotation of the control member 209 in the other direction causes the actuating portion 210 to move linearly in the opposite direction which draws the elongate housing member 211, and hence the blade 212, into a retracted position. In the engaging position, the blade 212 contacts a cable placed on the cable mounting portion 203 which therefore clamps the cable between the mounting portion 203 and the blade 212. In the retracted position the blade 212 is remote from the cable mounting portion 203 allowing a cable to be placed in the tool 200.

In use, the slide assembly 204 is moved from the cable mounting portion 203 to its retracted position to allow the cable Ito be placed on the rollers 206, 207 of the mounting portion 203. In particular, the cable 1 is placed in the first mounting orientation such that the cable is parallel to the rollers 206, 207 and lies such that the cable 1 abuts both rollers 206, 207. The moveable blade assembly 205 is then brought into contact with the cable 1 by rotating the control member 209 in one direction as described above. The user rotates the control member 209 until they feel a change in resistance caused by the blade 212 contacting the armour wires 8. The tool 200 can then be rotated about the cable 1 to effect a circumferential cut. The blade 212 is then moved to the retracted position as described above and the cable 1 can then either be moved longitudinally in the first mounting orientation a predetermined amount so that a second circumferential cut can be made, or the cable can be rotated 90° to the second mounting orientation so that a longitudinal cut can be effected.

Equally, the blade 212 may act upon the steel armour wires 8 in addition to the sheath 9.

In an alternative embodiment of the invention the rollers 204, 205 may be substituted by a plurality, e.g. four, of resiliently mounted ball-bearings, as shown in FIG. 12.

In FIG. 12 there is shown a tool 300 comprising a body 301 that includes an arm 302, a cable mounting portion 303 and a cover portion 304. The cover portion 304 holds in place four resiliently mounted ball bearings 305. The ball-bearings 305 extend through apertures in the cover portion 304 and are each able to rotate freely about their centre point. First 306 and second 307 cable mounting orientations are clearly shown in which cable 1 can be placed for cutting. Arm 302 upstands from mounting portion 303 in a direction 308 between the first 306 and second 307 cable mounting orientations (this is the same as tool 200 in the previous embodiment). As will be appreciated, this means that tools 200, 300 can be easily rotated about cable 1 by the user without restricting the view of the cutting zone.

Furthermore, it will be appreciated that tools 200, 300 having a single blade are more compact than tools having two blades. Tools having a single blade can therefore be operated by the user in a neater and more ergonomic fashion.

1. A cable stripping tool having a body comprising an arm, a cable mounting portion and a blade assembly that is movable between a retracted position and an engaging position, the cable mounting portion comprising means having first and second cable mounting axes, wherein the arm extends from the cable mounting portion in a direction between the first and second mounting axes.

2. A cable stripping tool according to claim 1, wherein the first cable mounting axis is substantially 90° to the second cable mounting axis.

3. A cable stripping tool according to claim 1 or claim 2, wherein the arm extends from the mounting portion at approximately 45° from the first cable mounting axis.

4. A cable stripping tool according to any preceding claim, wherein the arm is formed integrally with the mounting portion.

5. A cable stripping tool according to any preceding claim, wherein a distal end of the arm supports the blade assembly.

6. A cable stripping tool according to any preceding claim, wherein the arm is curved upwards with respect to the mounting portion.

7. A cable stripping tool according to any preceding claim, wherein the blade assembly comprises a blade.

8. A cable stripping tool according to claim 7, wherein the blade is directly above the mounting portion.

9. A cable stripping tool according to claim 7 or claim 8, wherein the blade is directly above the point in which the first and second cable mounting axes intersect.

10. A cable stripping tool according to any preceding claim, wherein the blade assembly reciprocates linearly between the engaging and the retracted positions.

11. A cable stripping tool according to any preceding claim, wherein the blade assembly is operable by control of a control member.

12. A cable stripping tool according to any preceding claim, wherein the blade assembly is operable to impart sufficient force on the blade to allow the blade to cut through the steel armour wire of an armoured cable.

13. A cable stripping tool according to any preceding claim, in which the blade assembly includes a slide member that guides the blade assembly between the retracted position and the engaging position, the slide member including a slide assembly that controls the movement of the slide member.

14. A cable stripping tool according to claim 13, in which the slide assembly comprises a screw threaded member that controls movement of the blade assembly on its rotation.

15. A cable stripping tool according to claim 13 or claim 14, in which the slide assembly includes a ratchet mechanism.

16. A cable stripping tool according to any preceding claim, in which the mounting portion comprises a pair of rollers arranged parallel to one another, both rollers having a circumferential groove.

17. A cable stripping tool according to claim 16, in which the rollers may both include a circumferential ridge.

18. A cable stripping tool according to any one of claims 1 to 15, in which the mounting portion comprises a plurality, usually at least four, of resiliently mounted ball-bearings.

19. A cable stripping tool comprising a body, a cable mounting portion and a blade assembly that is movable relative to the cable mounting portion between a retracted position and an engaging position, the blade assembly comprising a first blade and a second blade and wherein the first blade is connected to the second blade such that, in use, the pressure applied by the second blade to a cable is lower than the pressure applied by the first blade.

20. A cable stripping tool, comprising a body, a cable mounting portion and a blade assembly that is movable relative to the cable mounting portion between a retracted position and an engaging position, the blade assembly comprising a first blade, the mounting portion being arranged to receive the cable in a first orientation and a second orientation, and comprise means to permit rotation of the cable relative to the tool in both the first and second orientations.

21. A cable stripping tool comprising a body, a cable mounting portion and a blade assembly that is movable relative to the cable mounting portion between a retracted position and an engaging position, the blade assembly comprising a first blade and a second blade and wherein the second blade is movable relative to the first blade between an operable position and an inoperable position.

22. A kit for connecting to a cable cutting device comprising a body, a cable mounting portion and a first blade support that is movable relative to the cable mounting portion between a retracted position and an engaging position, the kit comprising a second blade assembly adapted to connect to the first blade support such that it is movable with the first blade support between the retracted and engaging positions, wherein, when mounted to the first blade support; the second blade assembly and the first blade support provide two parallel blades, and in which, when the kit is mounted on the cable cutting device, the mounting portion is arranged to receive the cable in a first orientation and a second orientation, and comprise means to permit rotation of the cable relative to the tool in both the first and second orientations.

23. The kit of claim 22, comprising an extension mount for connection to the mounting portion and adapted to provide a mount for a cable when the device is in use, the extension mount comprising a set of rollers which extend, when mounted on the cable stripping tool, between the blades.

24. The kit of claim 22 or claim 23, comprising the cable stripping tool.
